(19) United States
(12) Patent Application Publication
(10) Pub. No.: US 2015/0199276 A1
(43) Pub. Date: Jul. 16, 2015

(54) PRE-FETCH CONFIRMATION QUEUE

(71) Applicant: Samsung Electronics Co., Ltd., Suwon-si (KR)

(72) Inventors: Arun RADHAKRISHNAN, Austin, TX (US); Karthik SUNDARAM, Austin, TX (US); Brian GRAYSON, Austin, TX (US)

(21) Appl. No.: 14/451,375

(22) Filed: Aug. 4, 2014

Related U.S. Application Data
(60) Provisional application No. 61/926,931, filed on Jan. 13, 2014.

(51) Int. Cl. G06F 12/08

(52) U.S. Cl. CPC G06F 12/0862; G06F 2212/6028; G06F 2212/6026

(57) ABSTRACT

According to one general aspect, a method may include receiving, by a pre-fetch unit, a demand to access data stored at a memory address. The method may include determining if a first portion of the memory address matches a prior defined region of memory. The method may further include determining if a second portion of the memory address matches a previously detected pre-fetched address portion. The method may also include, if the first portion of the memory address matches the prior defined region of memory, and the second portion of the memory address matches the previously detected pre-fetched address portion, confirming that a pre-fetch pattern is associated with the memory address.

### CROSS-REFERENCE TO RELATED APPLICATION

This application claims priority under 35 U.S.C. §119 to Provisional Patent Application Ser. No. 61/926,931, entitled “PRE-FETCH CONFIRMATION QUEUE” filed on Jan. 13, 2014. The subject matter of this earlier filed application is hereby incorporated by reference.

### TECHNICAL FIELD

This description relates to information storage, and more specifically to memory cache management.

### BACKGROUND

Generally computers and the programs executed by them have a voracious appetite for unlimited amounts of fast memory. Unfortunately, memory (especially fast memory) is generally expensive both in terms of cost and die area. The traditional solution to the desire for unlimited, fast memory is a memory hierarchy or system of tiers or levels of memories. In general, the tiered memory system includes a plurality of levels of memories, each level slower but larger than the previous tier.

A typical computer memory hierarchy may include three levels. The fastest and smallest memory (often called a “Level 1 (L1) cache”) is closest to the processor and includes static random access memory (RAM and SRAM). The next tier or level is often called a Level 2 (L2) cache, and is larger but slower than the L1 cache. The third level is the main memory and generally includes dynamic RAM (DRAM), often inserted into memory modules. However, other systems may have more or less memory tiers. Also, in some systems the processor registers and the permanent or semi-permanent storage devices (e.g., hard drives, solid state drives, etc.) may be considered part of the memory system.

The memory system generally makes use of a principle of inclusiveness, wherein the slowest but largest tier (e.g., main memory, etc.) includes all of the data available. The second tier (e.g., the L2 cache, etc.) includes a sub-set of that data, and the next tier from that (e.g., the L1 cache, etc.) includes a second sub-set of the second tier's subset of data, and so on. As such, all data included in a faster tier is also included by slower tier.

Generally, the caches decide what sub-set of data to include based upon the principle of locality (e.g., temporal locality, spatial locality, etc.). It is assumed that a program will wish to access data that it has either recently accessed or is next to the data it has recently accessed. For example, if a movie player program is accessing data, it is likely that the movie player will want to access the next few seconds of the movie, and so on.

However, occasionally a program will request a piece of data that is not available in the fastest cache (e.g., the L1 cache, etc.). That is generally known as a “cache miss” and causes the fastest cache to request the data from the next memory tier (e.g., the L2 cache). This is costly to processor performance as a delay is incurred in determining that a cache miss has occurred, retrieving the data by the L1 cache, and providing it to the processor. Occasionally, the next tier of memory (e.g., the L2 cache, etc.) may not include the requested data and must request it from the next tier (e.g., main memory, etc.). This generally costs further delays.

### SUMMARY

According to one general aspect, a method may include receiving, by a pre-fetch unit, a demand to access data stored at a memory address. The method may include determining if a first portion of the memory address matches a prior defined region of memory. The method may further include determining if a second portion of the memory address matches a previously detected pre-fetched address portion. The method may also include, if the first portion of the memory address matches the prior defined region of memory, and the second portion of the memory address matches the previously detected pre-fetched address portion, confirming that a pre-fetch pattern is associated with the memory address.

According to another general aspect, an apparatus may include a pattern identifier and a pre-fetch confirmer. The pattern identifier may be configured to predict data access of a plurality of instruction streams. The pre-fetch confirmer may be configured to determine, via a two-stage lookup, if an actual data access was predicted by the pattern identifier.

According to another general aspect, a system may include an execution unit, a memory, and a pre-fetch unit. The execution unit may be configured to execute one or more instruction streams, wherein the execution unit is configured to perform an actual data access as instructed by the one or more instruction streams. The pre-fetch unit may be configured to predict data access of a plurality of instruction streams, and determine, via a two-stage lookup and a confirmation data structure, if an actual data access was predicted. The memory configured to store data accessed by the one or more instruction streams.

The details of one or more implementations are set forth in the accompanying drawings and the description below. Other features will be apparent from the description and drawings, and from the claims.

A system and/or method for information storage, and more specifically to memory cache management, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a diagram of an example embodiment of a data structure in accordance with the disclosed subject matter.

FIG. 3 is a diagram of an example embodiment of a data structure in accordance with the disclosed subject matter.

FIG. 4 is a flowchart of an example embodiment of a technique in accordance with the disclosed subject matter.

FIG. 5 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

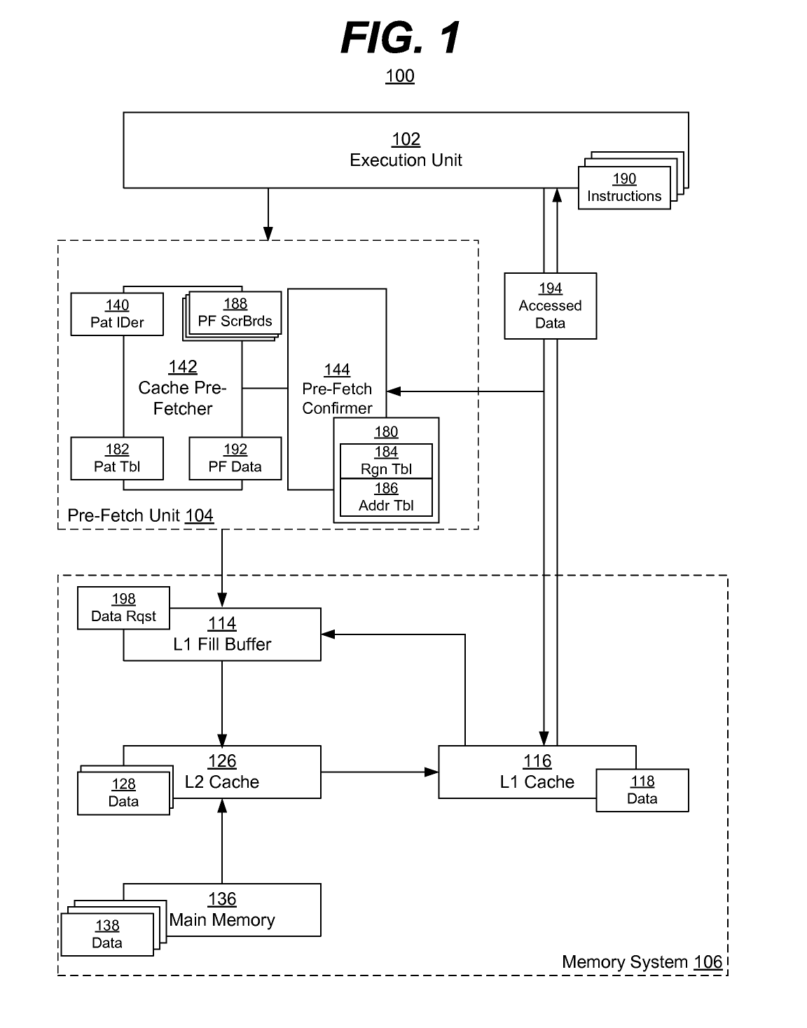

FIG. 1 is a block diagram of an example embodiment of a system 100 in accordance with the disclosed subject matter. In various embodiments, the system 100 may include a three-tier memory system 106 (e.g., L1 cache 116, L2 cache 126, and main memory 136, etc.). It is understood that the above is merely one illustrative example to which the disclosed subject matter is not limited.

In various embodiments, the system 100 may include an execution unit 102 configured to execute or process one or more instructions 190. In such an embodiment, these instructions 190 may make up a program or application (or part thereof). In various embodiments, the execution unit 102 may be included by a processor or other larger computer component. In various embodiments, these instructions 190 may occasionally access (e.g., read from, write to, etc.) data stored in a memory system 106 (e.g., L1 cache 116, L2 cache 126, and main memory 136, etc.).

In such an embodiment, when these instructions 190 access data, they may first request the data from the L1 cache 116, as the first or fastest tier of the memory system 106. In one such embodiment, the L1 cache 116 may store a sub-set of data 118. If the requested data is included in the data 118, the L1 cache 116 may supply the data (or update the stored data 118 in the case of a write instruction 190), and the execution unit 102 may proceed without incident.

However, in various embodiments, if the requested data is not included in the data 118 (i.e. a cache miss), the L1 cache 116 may, in turn, request the data from the L2 cache 126 (i.e. the next level or tier in the memory system 106). This may have a detrimental or undesired effect on the ability of the execution unit 102 to proceed, and may cause the execution unit 102 to delay or stall the processing of the instructions 190.

Traditionally, the L1 cache 116 could only request one piece of data from the L2 cache 126 at a time. However, in the illustrated embodiment, the system 100 may include an L1 fill buffer 114 configured to queue data requests 198 to the L2 cache 126 made by the L1 cache 116 or on its behalf, as described herein. In such an embodiment, the L1 cache 116 may be able to accommodate additional requests for data from the execution unit 102, while awaiting the fulfillment of the data that caused the cache miss.

Likewise, the L2 cache 126 may store a sub-set of data 128. If the cache-miss data is included in the data 128, the data may be supplied to the L1 cache 116 relatively forthwith. If not, another cache miss is generated, this time at the L2 cache 126 level. The L2 cache 126 may request the missing data from the main memory 136 (or next tier in the memory system 106), and the main memory 136 is expected to have the data in its stored data 138. In various embodiments, the main memory 136 may only store a sub-set of data 138, and the entirety of possible data may be stored in a storage medium or other semi-permanent, or permanent memory device (e.g., hard drive, solid state device, optical disc, etc.), but that is not illustrated. It is understood that the above are merely a few illustrative examples to which the disclosed subject matter is not limited.

Cache misses are generally considered undesirable. In the illustrated embodiment, the system 100 may include a pre-fetch unit 104 configured to predict what data is likely to be requested by the instructions 190, and then cause that predicted data to be readily available in the memory system 106. In the illustrated embodiment, the pre-fetch unit 104 may reduce the number of cache misses directly caused by the instructions 190. In such an embodiment, by requesting data 192 before the instruction 190 that needs (or is expected to need) the data is executed, a cache miss caused by requesting the data 192 may be resolved by the time the instruction 190 needs the data 192. In such an embodiment, the execution unit 102 may not be aware that such a cache miss occurred, and may not stall or otherwise have its execution of the instructions 190 adversely affected. It is understood that the above is merely one illustrative example to which the disclosed subject matter is not limited.

In one embodiment, the cache pre-fetcher 142 may include a pattern identifier 140 configured to detect a pattern of memory accesses that occur as a result of the instructions 190. For example, a series or stream of instructions 190 may access memory address in a pattern of 3 kilobytes (KB), then 4 KB, then 4 KB (i.e., 3+4+4, etc.). In such an embodiment, the pattern identifier 140 may identify the pattern of memory access. It is understood that the above is merely one illustrative example to which the disclosed subject matter is not limited.

In various embodiments, the instructions 190 may include a number of streams of instructions. In this context, a stream of instructions, or instruction stream may be a series of instructions 190 all related to a common program, function, or subroutine, and executing in a sequence in order to accomplish a task. In modern computers, an execution unit 102 may be configured to execute one or more streams of instructions 190 substantially in parallel via techniques, such as, but not limited to multi-tasking, multi-threading, time slicing, etc.

In such an embodiment, the pattern identifier 140 may be configured to detect memory access patterns within the various streams of instructions 190. In such an embodiment, a first stream of instructions 190 may be associated with a first set of patterns of memory accesses (e.g., 3+4+4, 1+8+8, etc.) and a second stream of instructions 190 may be associated with a second set of patterns of memory accesses (e.g., 3+5+4, 4+8+8, 3+4+4, etc.). In various embodiments, two or more streams of instructions 190 may be associated with similar patterns. It is understood that the above are merely a few illustrative examples to which the disclosed subject matter is not limited.

In various embodiments, the pre-fetch unit 104 may include or maintain a pattern table 182 configured to store the detected or predicted memory access patterns. In various embodiments, the pattern table 182 may include a data structure stored within a memory included by the pre-fetch unit 104. In some embodiments, the pattern table 182 data structure may not include a table but may include another form of data structure (e.g., linked list, array, etc.). It is understood that the above is merely one illustrative example to which the disclosed subject matter is not limited.

In various embodiments, the cache pre-fetcher 142 may be configured to base its pre-fetch data 192 predictions upon, at least in part, the patterns stored in the pattern table 182. For example, if a 3+4+4 pattern is identified and a memory access to a memory address starting at a 3 KB boundary is detected, the cache pre-fetcher 142 may pre-fetch data 192 at the next two 4 KB boundaries. It is understood that the above is merely one illustrative example to which the disclosed subject matter is not limited.

However, it is desirable to confirm that the predictions made by the cache pre-fetcher 142 are valid or at least useful. In various embodiments, such a feedback mechanism may be employed to improve the predictions made by the pre-fetch unit 104.

In various embodiments, the pre-fetch unit 104 may include a pre-fetch confirmer 144. In the illustrated embodiment, the pre-fetch confirmer 144 may be configured to monitor data accesses made by the instructions 190 (or execution unit 102) and determine whether or not the cache pre-fetcher 142 (or pre-fetch unit 104, more generally) correctly predicted that the instructions 190 would access the actually accessed data 194. In various embodiments, based upon this feedback (positive and/or negative) the cache pre-fetcher 142 may adjust its prediction technique. In some embodiments, only feedback of one type (e.g., positive or negative, etc.) may be employed. It is understood that the above are merely a few illustrative examples to which the disclosed subject matter is not limited.

In the illustrated embodiment, the pre-fetch confirmer 144 may be configured to employ a two-stage lookup scheme to determine if the accessed data 194 conforms to a pre-detected or prior defined pattern or memory address. In such an embodiment, the two-stage lookup scheme may use less computational time and power due to the ability to abort the lookup and confirmation process if the first stage fails. Further, additional advantages may include a reduction in a number or width of bits that are compared, as described below.

In the illustrated embodiment, the pre-fetch confirmer 144 may be configured to employ a unified confirmation table 180 or data structures (e.g., the region table 184, the address table 186, etc.). In various embodiments, a pre-fetch confirmer 144 may be employed to maintain separate data structures for each instruction stream. In some embodiments, this may be because it is assumed that each stream of instructions will have different patterns. However, as described above, the pre-fetch confirmer 144 may be configured to employ a confirmation table 180 that is unified in terms of the instruction streams (even if the confirmation table 180 is split in terms of a two-stage lookup structure). In such an embodiment, the pre-fetch confirmer 144 may be configured to provide a more efficient use of a fixed amount of memory storage by dividing the usage of the storage across multiple instructions streams. It is understood that the above is merely one illustrative example to which the disclosed subject matter is not limited.

In the illustrated embodiment, the pre-fetch confirmer 144 may be configured to receive a data access request (e.g., a load, a store, a read, a write, etc.) from the execution unit 102. In various embodiments, this data access request may be associated with the accessed data 194 and may include a particular memory address where the accessed data 194 is stored. In various embodiments, the data access request may also be received by the memory system 106 and may be processed as described above.

In various embodiments, the pre-fetch confirmer 144 may be configured to determine if the access data 194 (or at least the memory address associated with it) have been pre-fetched or predicted by the pre-fetch unit 104. In one such embodiment, the pre-fetch confirmer 144 may be configured to determine if an upper portion of the memory address matches a prior defined region of memory. In one such embodiment, this may be accomplished by determining if the memory address, or upper portion of the memory address is associated with an entry in the region table 184.

In the illustrated embodiment, the pre-fetch confirmer 144 may maintain a data structure referred to as a region table 184. Again, in various embodiments, the region table 184 may include data structures other than a table (e.g., linked list, hash table, array, associative array, etc.). In various embodiments, the region table 184 may include a number of entries that associate regions, portions, or blocks of memory or memory addresses with patterns (e.g., stored in the pattern table 182). In the illustrated embodiment, as part of a two-stage lookup scheme the region table 184 may associate the memory regions with the patterns indirectly, and an entry in the region table 184 may signify that at least some parts of the memory region as associated with one or more patterns. In the illustrated embodiment, further examination of the address table 186 may be required.

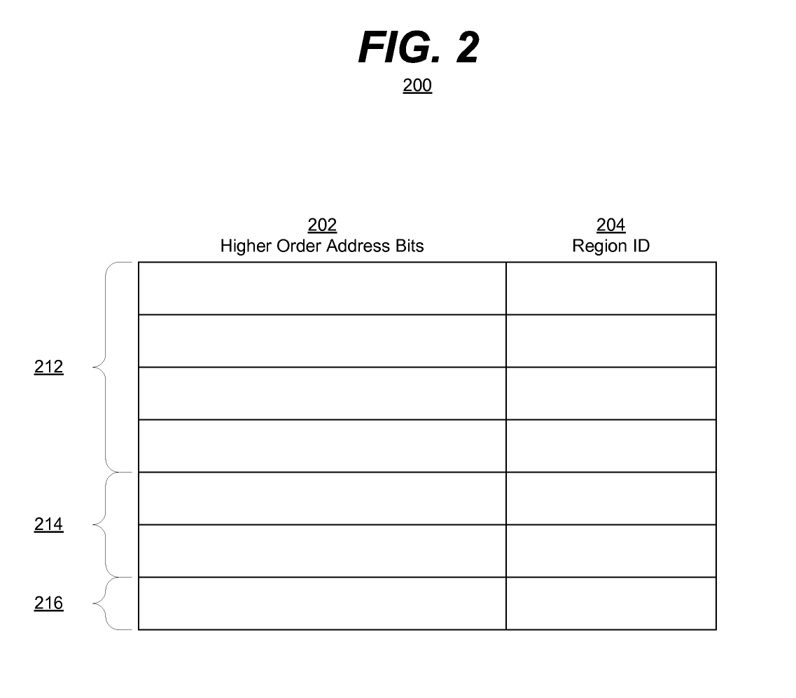

In such an embodiment, when presented with the accessed data 194, the pre-fetch confirmer 144 may use the upper or most significant bits (MSBs) of the memory address of the accessed data 194 as a key to the region table 184. In various embodiments, the region table 184, as described below in reference to FIG. 2, may include a column or key for the MSBs of address regions and a column or value for a region identifier (ID). In various embodiments, the region ID may include fewer bits than the MSBs. It is understood that the above is merely one illustrative example to which the disclosed subject matter is not limited.

If the key or MSBs are not found in the region table 184, the pre-fetch confirmer 144 may determine that the accessed data 194 is new data that has not been predicted or pre-fetched by the pre-fetch unit 104. In some embodiments, the accessed data 194 may be from a new stream of instructions. In another embodiment, the accessed data 194 may be from a preexisting or previously encountered stream of instructions, but may not be part of a previously detected pattern of memory accesses. It is understood that the above are merely a few illustrative examples to which the disclosed subject matter is not limited.

In such an embodiment, the pre-fetch confirmer 144 may pass the memory access to the cache pre-fetcher 142 or pattern identifier 140. In such an embodiment, the new memory access may be employed to train the pre-fetch unit 104 to better predict memory accesses. In various embodiments, this may cause the pattern identifier 140 to adjust exiting identified patterns, create new patterns, or otherwise adjust the state machine or scheme employed to detect patterns. It is understood that the above are merely a few illustrative examples to which the disclosed subject matter is not limited.

If the key or MSBs are found in the region table 184, a region identifier (ID) or value may be returned. In one embodiment, once the memory region associated with the accessed data 194 is found to be valid or associated with an entry in the region table 184, the pre-fetch confirmer 144 may attempt to determine if the lower portion or least significant bits (LSBs) of the memory address match a previously detected pre-fetched address portion or pattern.

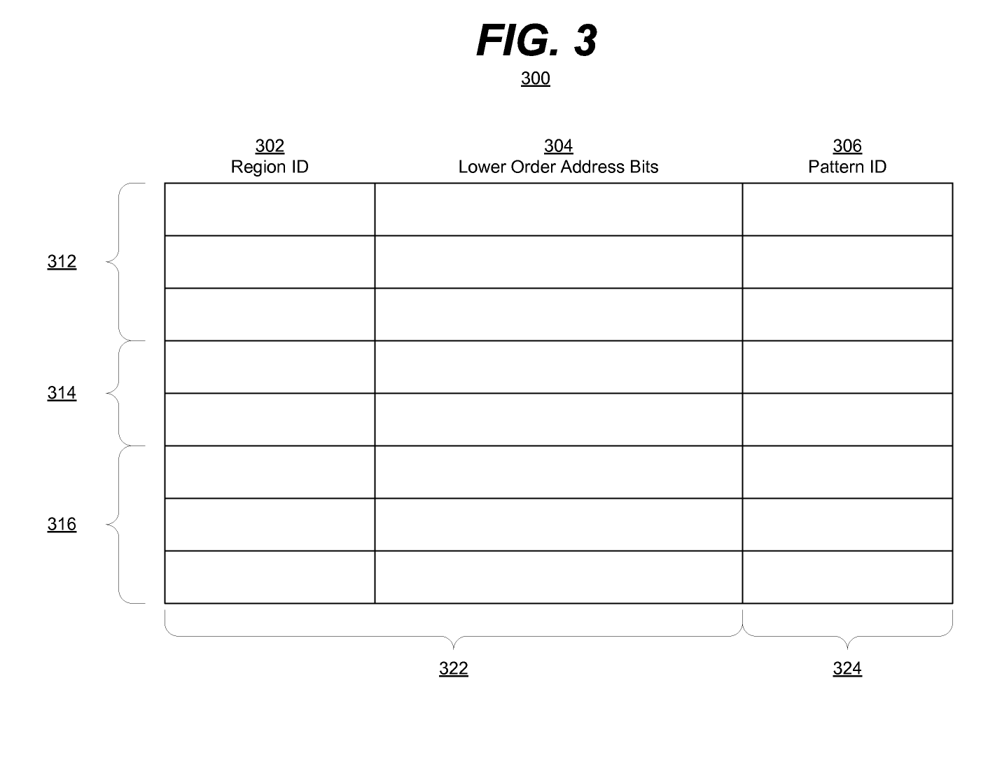

In the illustrated embodiment, the address table 186, as described below in reference to FIG. 3, may include a column that that includes the LSBs of various memory addresses, a column of the region IDs, and a third column the includes a pattern or pattern identifier (ID) that is associated with the other two columns. In one embodiment, the region ID and LSB of the memory address may be employed as a key and the pattern ID may be the value returned in response to the key. In various embodiments, the pattern ID may, in turn, act as a key or index to the pattern table 182. It is understood that the above are merely a few illustrative examples to which the disclosed subject matter is not limited.

If the key, or region ID and LSBs are not found in an entry in the address table 186, the pre-fetch confirmer 144 may determine that the accessed data 194 is new data that has not been predicted or pre-fetched by the pre-fetch unit 104. In some embodiments, the accessed data 194 may be from a new stream of instructions. In another embodiment, the accessed data 194 may be from a preexisting or previously encountered stream of instructions, but may not be part of a previously detected pattern of memory accesses, as described above. It is understood that the above are merely a few illustrative examples to which the disclosed subject matter is not limited.

If the key, or region ID and LSBs are found in an entry in the address table 186, a pattern, pattern identifier (ID), or value may be returned. In one embodiment, once the pattern associated with the accessed data 194 is found, the pre-fetch confirmer 144 may inform the cache pre-fetcher 142 that its detection of the pattern and the prediction as to the pre-fetch data 192 is correct. In such an embodiment, the cache pre-fetcher 142 may use the confirmation that its predicted pattern was correct to aid future predictions and pattern detections. It is understood that the above are merely a few illustrative examples to which the disclosed subject matter is not limited.

In one embodiment, the splitting of the confirmation table 180 into a region table 184 and address table 186 may have various benefits over a single amalgamated confirmation table. In one such embodiment, as an address or key comparison occurs only against a sub-portion of the memory address, the number of bit comparators, data bus, and storage requirements are reduced (compared to a full address comparison). For example, the MSB portion need only be stored once in the region table 184, but may be re-used (via the region ID) multiple times in the address table 186 in a shorter and smaller fashion. Further, in one embodiment, by engaging in a two-stage lookup, both computational time and power may be saved as the process may be aborted if no entry is found within the region table 184. It is understood that the above are merely a few illustrative examples to which the disclosed subject matter is not limited.

In another embodiment, the region table 184 and address table 186 may include entries from all instruction streams, as described above. As described below in reference to FIGS. 2 & 3, the region table 184 and address table 186 (or pre-fetch unit 104) may be able to dynamically allocate the entries or rows amongst the various instruction streams. In such an embodiment, the region table 184 and address table 186 may use a fixed amount of storage that is spread across the multiple instruction streams. This is compared to a system that may employ separate tables, of fixed sizes, for each instruction stream.

In one embodiment, the region table 184 and address table 186 (taken as a whole) may provide improved capabilities to handle non-sequential strides in memory accesses. In one such embodiment, the region table 184 and address table 186 may include entries (or rows) that each use a fixed amount of storage. In such an embodiment, each pre-fetch data 192 request may be associated with an entry in the address table 186. In such an embodiment, this fixed amount of storage per entry or pre-fetch request, may require less storage than an alternate system that employs a fixed storage per memory area that may be pre-fetched (e.g., a bitmap system, etc.).

In various embodiments, the cache pre-fetcher 142 may be configured to operate using physical addresses that are often grouped into memory pages. In various embodiments, the memory pages may be grouped in pages of four kilobytes (KB) in size. In such an embodiment, the pre-fetch unit 104 may re-train or re-evaluate its predictions when a physical address 196 exceeds or crosses such a page boundary. Further, physical addresses are often dis-contiguous and may not be located next to each other. It is understood that the above are merely a few illustrative examples to which the disclosed subject matter is not limited.

In such an embodiment, a two-stage confirmation table 180 (including a region table 184 and an address table 186) may enable simple page-crossing pre-fetch embodiments. In various embodiments, the region table 184 may reduce the cost of multiple region addresses across multiple instruction streams. It is understood that the above are merely a few illustrative examples to which the disclosed subject matter is not limited.

In the illustrated embodiment, the cache pre-fetcher 142 may make use of the virtual addresses. In various embodiments, the region table 184 and an address table 186 may be employed with virtual addresses and/or physical addresses. It is understood that the above are merely a few illustrative examples to which the disclosed subject matter is not limited.

In various embodiments, the region table 184 and address table 186 (taken as a whole) may provide a single physical point of comparison between predicted memory accesses (e.g., pre-fetch data 192, etc.) and actual memory accesses (e.g., accessed data 194, etc.). This is contrasted with more distributed systems that may compare accessed data 194 against various pre-fetch data scoreboards 188. In such an embodiment, the pre-fetch data scoreboards 188 may be configured to keep track of data requested by the cache pre-fetcher 142. In various embodiments, a plurality of pre-fetch data scoreboards 188 include, in respective scoreboards, outstanding requests for pre-fetch data 192, completed requests for pre-fetch data 192, and/or pending requests for pre-fetch data 192. In some embodiments, these pre-fetch data scoreboards 188 may be disbursed throughout the pre-fetch unit 104 structure. For example, a first pre-fetch data scoreboard 188 may be focused on pending requests that have yet to be placed in the L1 fill buffer 114 (or memory system 106, in general). A second pre-fetch data scoreboard 188 may be separate from the first and focused on outstanding requests 198 that been placed in the L1 fill buffer 114 (or memory system 106, in general) but have not been stored in the L1 cache 116. While a third pre-fetch data scoreboard 188 may be separate from the first and second, and focused on completed requests 198 that been stored in the L1 cache 116. In the illustrated embodiment, the region table 184 and address table 186 (taken as a whole) may remove the need to compare the accessed data 194 against multiple desperate data structures (e.g., three separate pre-fetch scoreboards 188, etc.). It is understood that the above are merely a few illustrative examples to which the disclosed subject matter is not limited.

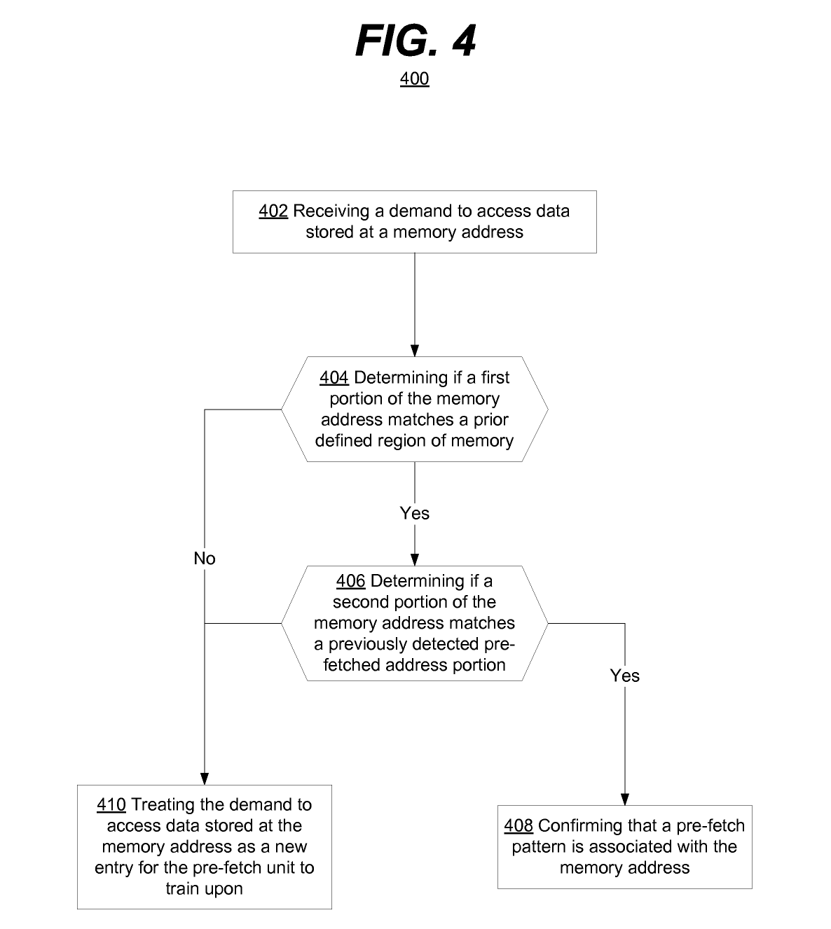

In various embodiments, as described below in reference to FIG. 4, the two-stage lookup process may be employed as a filter to the training process. In such an embodiment, as memory addresses are presented to the pre-fetch unit 104, the memory addresses may be checked against the region table 184 and address table 186. If the memory address is not already stored in the two tables 184 & 186, the pre-fetch unit 104 may treat the memory address as a new address to train upon. If the memory address is already stored in the two tables 184 & 186, the pre-fetch unit 104 may avoid re-training upon existing or pre-detected instruction streams. In various embodiments, only misses in the cache and the fill buffer that do not match against the two-stage structure may be used for training purposes. It is understood that the above is merely one illustrative example to which the disclosed subject matter is not limited.

FIG. 2 is a diagram of an example embodiment of a data structure 200 in accordance with the disclosed subject matter. In various embodiments, the data structure 200 may include a region table, as described above. It is understood that the above is merely one illustrative example to which the disclosed subject matter is not limited.

In one embodiment, the data structure 200 may include two fields or columns. A first or key column 202 that includes the higher order address bits or MSBs. In various embodiments, the width of the MSB portion, and the key column 202 may vary based upon the embodiment. In such an embodiment, the MSB portion may define a region of memory that is associated with a pattern or a pre-fetched data.

In various embodiments, the data structure 200 may include a second or value column 204 that include a region identifier (ID) that is associated with the portion of the memory address stored in the respective MSB column 202. As described below, this region ID may be employed in accessing the address table or data structure of FIG. 3.

In various embodiments, the entries or rows of the data structure 200 may be dynamically allocated amongst one or more instruction streams. In the illustrated embodiment, four rows 212 may be allocated to a first instruction stream. In the illustrated embodiment, two rows 214 may be allocated to a second instruction stream, and a final row 216 may be allocated with a third instruction stream. It is understood that the above is merely one illustrative example to which the disclosed subject matter is not limited.

In various embodiments, the allocation of rows may be fixed for a particular run or execution of the system employing the data structure 200. In another embodiment, the allocation of rows may dynamically vary or be re-allocated over time as the needs of the various instruction streams change. For example, as the second instruction stream grows the number of rows allocated to it may increase. Further, if the first instruction stream completes, the rows 212 allocated to it may be reallocated to the other instruction streams. In yet another embodiment, the rows 212 previously allocated to the first instruction stream may lie fallow until a new or fourth instruction stream begins execution. It is understood that the above are merely a few illustrative examples to which the disclosed subject matter is not limited.

FIG. 3 is a diagram of an example embodiment of a data structure 300 in accordance with the disclosed subject matter. In various embodiments, the data structure 300 may include an address table, as described above. It is understood that the above is merely one illustrative example to which the disclosed subject matter is not limited.

In one embodiment, the data structure 300 may include three fields or columns. A first column 302 may include the region ID output by the region table. In various embodiments, the region ID may stand for or represent the MSBs of the memory address. In such an embodiment, the region ID may employ or include fewer bits than the MSBs of the memory address. A second column 304 may include the lower order address bits or LSBs, as described above. In various embodiments, the first column 302 and second column 304 may operate together as a key 322 that is used to retrieve the desired output or value 324. In the illustrated embodiment, the value 324 may include the third column 306.

In such an embodiment, the data structure 300 may include a third column 306 that includes the pattern ID associated with the memory address. In the illustrated embodiment, the association may be determined in two stages that decrease the number of bits that have to be compared at any one time (and hence the computational power, time, and space, etc.) and provide a way to abort the comparison process if a match is not determined. In various embodiments, the pattern ID may be used as a key to a pattern table. In such an embodiment, the output of that pattern table lookup may be a pattern of memory accesses identified or predicted by the pre-fetch unit. As described above, in various embodiments, once this pattern has been confirmed or reinforced the training engine may improve the predictive nature of the pre-fetch unit. It is understood that the above are merely a few illustrative examples to which the disclosed subject matter is not limited.

As described above, in various embodiments, the allocation of rows may occur dynamically. In various embodiments, the allocation of rows within the data structure 300 may differ from the allocation in the region table. For example, in the illustrated embodiment, three rows 312 may be allocated to a first instruction stream. Two rows 314 may be allocated to a second instruction stream. And, three rows 316 may be allocated to a third instruction stream.

FIG. 4 is a flow chart of an example embodiment of a technique in accordance with the disclosed subject matter. In various embodiments, the technique 400 may be used or produced by the systems such as those of FIG. 1 or 4. In various embodiments, the technique 400 may use or employ data structures such as those of FIG. 2 or 3. Although, it is understood that the above are merely a few illustrative examples to which the disclosed subject matter is not limited. It is understood that the disclosed subject matter is not limited to the ordering of or number of actions illustrated by technique 400.

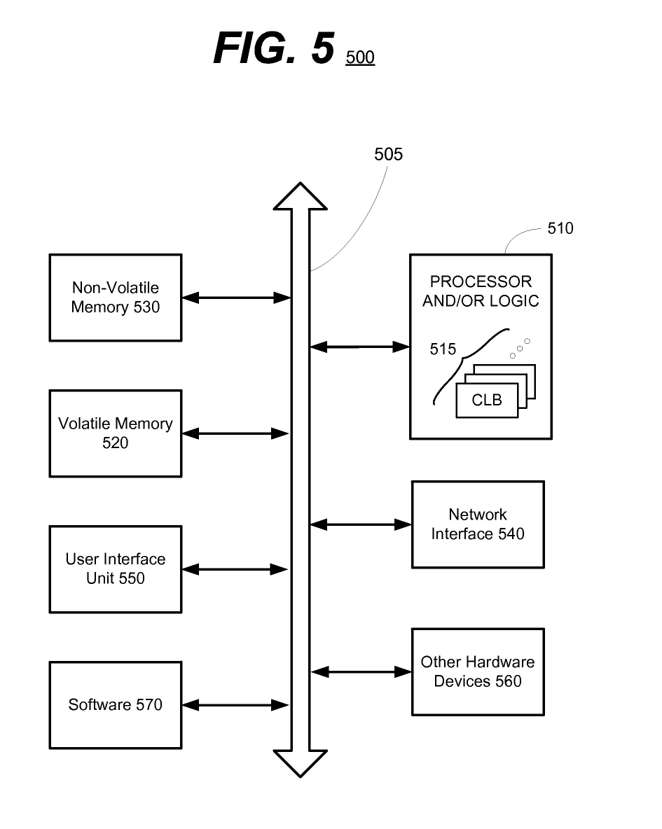

Block 402 illustrates that, in one embodiment, a demand to access data stored at a memory address may be received, as described above. In various embodiments, the demand may be received by a pre-fetch unit, as described above. In some embodiments, the pre-fetch unit may be configured to, substantially simultaneously, pre-fetch data for a plurality of instruction streams, as described above. In various embodiments, one or more of the action(s) illustrated by this Block may be performed by the apparatuses or systems of FIG. 1 or 5, or the pre-fetch unit 104 of FIG. 1, as described above.

Block 404 illustrates that, in one embodiment, it may be determined if a first portion of the memory address matches a prior defined region of memory, as described above. In some embodiments, determining if the first portion of the memory address matches may comprise detecting if the first portion of the memory address matches an entry in a first data structure, as described above. In various embodiments, determining if the first portion of the memory address matches may comprise determining if the first portion of the memory address matches for a prior defined region associated with any of the instructions streams, as described above. In various embodiments, one or more of the action(s) illustrated by this Block may be performed by the apparatuses or systems of FIG. 1 or 5, or the pre-fetch unit 104 of FIG. 1, as described above.

Block 406 illustrates that, in one embodiment, it may be determined if a second portion of the memory address matches a previously detected pre-fetched address portion, as described above. In some embodiments, determining if the second portion of the memory address matches may comprise detecting if the second portion of the memory address matches an entry in a second data structure. In various embodiments, determining if the second portion of the memory address matches may comprise comparing against at least an outstanding pre-fetched portion, a pending pre-fetched portion, and a completed pre-fetched portion, as described above. In various embodiments, determining if the first portion of the memory address matches and determining if the second portion of the memory address matches may include an abbreviated two-stage look-up, as described above. In various embodiments, one or more of the action(s) illustrated by this Block may be performed by the apparatuses or systems of FIG. 1 or 5, or the pre-fetch unit 104 of FIG. 1, as described above.

Block 408 illustrates that, in one embodiment, if the first portion of the memory address matches the prior defined region of memory, and the second portion of the memory address matches the previously detected pre-fetched address portion, it may be confirmed that a pre-fetch pattern is associated with the memory address, as described above. In some embodiments, if the first and second portions of the memory address match their respective values the demand to access data stored at the memory address may be treated as an entry for the pre-fetch unit to re-enforce prior training, as described above. In various embodiments, one or more of the action(s) illustrated by this Block may be performed by the apparatuses or systems of FIG. 1 or 5, or the pre-fetch unit 104 of FIG. 1, as described above.

Block 410 illustrates that, in one embodiment, if either or both of the first portion of the memory address does not match the prior defined region of memory, and the second portion of the memory address do not match the previously detected pre-fetched address portion, the pre-fetch unit may be trained based, at least in part, upon the memory address, as described above. In some embodiments, if the first portion of the memory address does not match a prior defined region of memory, determining if the second portion of the memory address matches may be skipped, and the demand to access data stored at the memory address may be treated as a new entry for the pre-fetch unit to train upon, as described above. In various embodiments, one or more of the action(s) illustrated by this Block may be performed by the apparatuses or systems of FIG. 1 or 5, or the pre-fetch unit 104 of FIG. 1, as described above.

FIG. 5 is a schematic block diagram of an information processing system 500, which may include semiconductor devices formed according to principles of the disclosed subject matter.

Referring to FIG. 5, an information processing system 500 may include one or more of devices constructed according to the principles of the disclosed subject matter. In another embodiment, the information processing system 500 may employ or execute one or more techniques according to the principles of the disclosed subject matter.

In various embodiments, the information processing system 500 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 500 may be used by a user (not shown).

The information processing system 500 according to the disclosed subject matter may further include a central processing unit (CPU), logic, or processor 510. In some embodiments, the processor 510 may include one or more functional unit blocks (FUBs) or combinational logic blocks (CLBs) 515. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 500 according to the disclosed subject matter may further include a volatile memory 520 (e.g., a Random Access Memory (RAM), etc.). The information processing system 500 according to the disclosed subject matter may further include a non-volatile memory 530 (e.g., a hard drive, an optical memory, a NAND or Flash memory, etc.). In some embodiments, either the volatile memory 520, the non-volatile memory 530, or a combination or portions thereof may be referred to as a “storage medium”. In various embodiments, the volatile memory 520 and/or the non-volatile memory 530 may be configured to store data in a semi-permanent or substantially permanent form.

In various embodiments, the information processing system 500 may include one or more network interfaces 540 configured to allow the information processing system 500 to be part of and communicate via a communications network. Examples of a Wi-Fi protocol may include, but are not limited to, Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to, IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 500 according to the disclosed subject matter may further include a user interface unit 550 (e.g., a display adapter, a haptic interface, a human interface device, etc.). In various embodiments, this user interface unit 550 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 500 may include one or more other devices or hardware components 560 (e.g., a display or monitor, a keyboard, a mouse, a camera, a fingerprint reader, a video processor, etc.). It is understood that the above are merely a few illustrative examples to which the disclosed subject matter is not limited.

The information processing system 500 according to the disclosed subject matter may further include one or more system buses 505. In such an embodiment, the system bus 505 may be configured to communicatively couple the processor 510, the volatile memory 520, the non-volatile memory 530, the network interface 540, the user interface unit 550, and one or more hardware components 560. Data processed by the processor 510 or data inputted from outside of the non-volatile memory 530 may be stored in either the non-volatile memory 530 or the volatile memory 520.

In various embodiments, the information processing system 500 may include or execute one or more software components 570. In some embodiments, the software components 570 may include an operating system (OS) and/or an application. In some embodiments, the OS may be configured to provide one or more services to an application and manage or act as an intermediary between the application and the various hardware components (e.g., the processor 510, a network interface 540, etc.) of the information processing system 500. In such an embodiment, the information processing system 500 may include one or more native applications, which may be installed locally (e.g., within the non-volatile memory 530, etc.) and configured to be executed directly by the processor 510 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 510.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, etc.). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. A method comprising:
receiving, by a pre-fetch unit, a demand to access data stored at a memory address;
determining if a first portion of the memory address matches a prior defined region of memory;
determining if a second portion of the memory address matches a previously detected pre-fetched address portion; and
if the first portion of the memory address matches the prior defined region of memory, and the second portion of the memory address matches the previously detected pre-fetched address portion, confirming that a pre-fetch pattern is associated with the memory address.

2. The method of claim 1, wherein, if either or both the first portion of the memory address does not match the prior defined region of memory, or the second portion of the memory address do not match the previously detected pre-fetched address portion, training the pre-fetch unit based, at least in part, upon the memory address.

3. The method of claim 1, wherein the determining if the first portion of the memory address matches comprises detecting if the first portion of the memory address matches an entry in a first data structure; and
wherein the determining if the second portion of the memory address matches comprises detecting if the second portion of the memory address matches an entry in a second data structure.

4. The method of claim 1, wherein the pre-fetch unit is configured to, substantially simultaneously, pre-fetch data for a plurality of instruction streams; and
wherein determining if the first portion of the memory address matches comprises determining if the first portion of the memory address matches for a prior defined region associated with any of the instructions streams.

5. The method of claim 1, wherein determining if the second portion of the memory address matches comprises comparing against at least an outstanding pre-fetched portion, a pending pre-fetched portion, and a completed pre-fetched portion.

6. The method of claim 1, further comprising, if the first portion of the memory address does not match a prior defined region of memory:
skipping determining if the second portion of the memory address matches; and
treating the demand to access data stored at the memory address as a new entry for the pre-fetch unit to train upon.

7. The method of claim 1, further comprising, if the first portion of the memory address matches a prior defined region of memory and a second portion of the memory address matches a previously detected pre-fetched address portion:
treating the demand to access data stored at the memory address as an entry for the pre-fetch unit to re-enforce prior training.

8. The method of claim 1, wherein determining if the first portion of the memory address matches and determining if the second portion of the memory address matches comprises:
an abbreviated two-stage look-up.

9. An apparatus comprising:
a pattern identifier configured to predict data access of a plurality of instruction streams; and
a pre-fetch confirmer configured to determine, via a two-stage lookup, if an actual data access was predicted by the pattern identifier.

10. The apparatus of claim 9, wherein the pre-fetcher confirmer is configured to maintain:
a first data structure that identifies one or more regions of memory in which data access has been predicted, and
a second data structure that associates memory addresses with one or more predicted patterns of data access.

11. The apparatus of claim 9, wherein the actual data access is associated with a memory address; and
wherein the pre-fetcher confirmer is configured to:
in a first stage of the two stage lookup, compare a first portion of the memory address to a list of one or more regions of memory in which data access has been predicted, and
in a second stage of the two stage lookup, at least, determine if an association exists between a second portion of the memory address and a predicted data access.

12. The apparatus of claim 9, wherein if either stage of the two-stage lookup fails, the pattern identifier is configured to treat the actual data access as a new data access upon which to predict future data accesses.

13. The apparatus of claim 9, wherein the pre-fetch confirmer is configured to determine if an actual data access was predicted in relation to any of the plurality of instruction streams.

14. The apparatus of claim 9, wherein the pre-fetch confirmer is configured to maintain a data structure that comprises a fixed amount of memory storage per a pre-fetch data request.

15. The apparatus of claim 9, wherein the pre-fetch confirmer is configured to maintain at least one data structure that comingles entries that represent any outstanding pre-fetch data requests, any pending pre-fetch data requests, and any completed pre-fetch data requests associated with an active instruction stream.

16. The apparatus of claim 9, wherein the pre-fetch confirmer is configured to:
maintain one or more data structures that associates memory addresses with one or more predicted patterns of data access in a comingled fashion, wherein the predicted patterns of data access are associated with respective instruction streams; and
dynamically allocate storage space within the one or more data structures to the instruction streams.

17. A system comprising:
an execution unit configured to execute one or more instruction streams, wherein the execution unit is configured to perform an actual data access as instructed by the one or more instruction streams;
a pre-fetch unit configured to:
predict data access of a plurality of instruction streams, and
determine, via a two-stage lookup and a confirmation data structure, if an actual data access was predicted; and
a memory configured to store data accessed by the one or more instruction streams.

18. The system of claim 17, wherein the confirmation data structure comprises:
a first data structure that identifies one or more regions of memory in which data access has been predicted, and
a second data structure that associates memory addresses with one or more predicted patterns of data access.

19. The system of claim 17, wherein the pre-fetch unit is configured to:
if a first stage of the two-stage lookup fails, treat the actual data access as a new data access upon which to predict future data accesses; and
if the first stage of the two-stage lookup succeeds, determine if the actual data access is associated with a predicted pattern of data access.

20. The system of claim 17, wherein the pre-fetch unit is configured to:
determine if an actual data access was predicted in relation to any of the plurality of instruction streams.
